(19) United States
(12) Patent Application Publication
(10) Pub. No.: US 2010/0059904 A1
(43) Pub. Date: Mar. 11, 2010

(54) IMPRINT APPARATUS

(75) Inventor: Kazuyuki Kasumi, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/556,435

(22) Filed: Sep. 9, 2009

(30) Foreign Application Priority Data
Sep. 11, 2008 (JP) 2008-232791

(51) Int. Cl. B29C 59/02

(52) U.S. Cl. 264/293; 425/149

(57) ABSTRACT

An imprint apparatus is configured to mold a resin on a substrate by using a mold and to form a pattern of the resin on the substrate. The imprint apparatus includes a holder configured to hold the substrate, the holder having a groove, an exhaust device configured to exhaust a gas in the groove so that the hold can hold the substrate by setting a pressure in the groove to a negative pressure, a supply device configured to supply the gas to the groove, and a controller configured to control the supply device so as to set the pressure in the groove to a positive pressure during molding.

### BACKGROUND OF THE INVENTION

1. Field of the Invention

The present invention relates to an imprint apparatus.

2. Description of the Related Art

A nanoimprint apparatus configured to press a mold having a pattern upon a substrate to which a resin (or resist) is applied, to release the mold after the resist is cured, and to transfer the pattern onto the substrate. The nanoimprint apparatus is increasingly required to make uniform a residual layer thickness so as to improve the yield. The “residual layer” is a layer in a concave of the resist on the substrate after the mold is released, and the residual layer thickness is a thickness of the layer at that portion. The residual layer corresponds to a convex of the mold pattern. Since it is ideal that there is no residual layer, the residual layer is removed by reactive ion etching (“RIE”). FIG. 9A is a sectional view showing that a residual layer RF exists on a (transferred) substrate W before the RIE is provided, and FIG. 9B is a sectional view showing that no residual layer exists on the substrate W after the RIE is provided. Reference symbol R denotes the resist, and a dotted line in FIG. 9B corresponds to FIG. 9A.

While the RIE removes the residual layer of the resin by using the anisotropy or the different etching velocities in the thickness direction and the lateral direction of the residual layer, the resin is actually etched in the lateral direction in addition to the thickness direction (longitudinal direction). When the residual layer thickness has a distribution, an etching amount in the lateral direction differs for each substrate. In the manufacture of the semiconductor, the precision of the critical dimension (“CD”) in the lateral direction is very strictly required, and the distribution of the residual layer thickness is required to be uniform. The residual layer thickness distribution also depends upon a groove in the chuck (holder) configured to hold the substrate due to the vacuum suction as well as a degree of flatness of the mold, a degree of flatness of the substrate, the parallelism between the mold and the substrate. L BENDFELDT, H SCHULZ, N ROOS, H-C SCHEER, “Groove design of vacuum chucks for hot embossing lithography,” Microelectronic Engineering 61-62, pp. 455-459, Elsevier Science (2002).

FIG. 10 is a sectional view showing that there is a distribution of the residual layer thickness. The substrate W is absorbed and held on the surface of the chuck C via a plurality of vacuum absorption grooves G provided in the surface of the chuck C. When the mold M is pressed upon the substrate W, no part supports the load in the vacuum absorption grooves G in the chuck C and the substrate W deforms downwardly. When the resin R cures in this state, the residual layer thickness becomes non-uniform.

### SUMMARY OF THE INVENTION

The present invention provides, for example, an imprint apparatus that is advantageous in uniformity of a residual layer thickness.

An imprint apparatus according to one aspect of the present invention for molding a resin on a substrate using a mold to form a pattern of a resin on the substrate includes a holder having a groove and configured to hold the substrate, an exhaust device configured to exhaust a gas in the groove so that a pressure in the groove is negative and the holder holds the substrate, a supply device configured to supply a gas to the groove, and a controller configured to control the supply device so that a pressure in the groove is positive during the molding.

Further features of the present invention will become apparent from the following description of exemplary embodiments with reference to the attached drawings.

### BRIEF DESCRIPTION OF THE DRAWINGS

FIG. 1 is a sectional view near a chuck of an imprint apparatus according to a first embodiment.

FIG. 2 is a perspective view of the chuck shown in FIG. 1.

FIG. 3 is a perspective view of a variation of the chuck shown in FIG. 2.

FIG. 4 is a sectional view of the imprint apparatus according to the first embodiment.

FIG. 5 is an enlarged sectional view for explaining a press state of the imprint apparatus shown in FIG. 4.

FIG. 6 is a plane view of the chuck according to a second embodiment.

FIG. 7 is a sectional view of the chuck shown in FIG. 6.

FIG. 8 is a block diagram of the imprint apparatus according to a third embodiment.

FIG. 9 is a sectional view showing a residual layer state before and after the conventional RIE.

FIG. 10 is an enlarged sectional view for explaining the problems of FIG. 9.

### DESCRIPTION OF THE EMBODIMENTS

A variety of embodiments of the present invention will now be described with reference to the accompanying drawings.

### First Embodiment

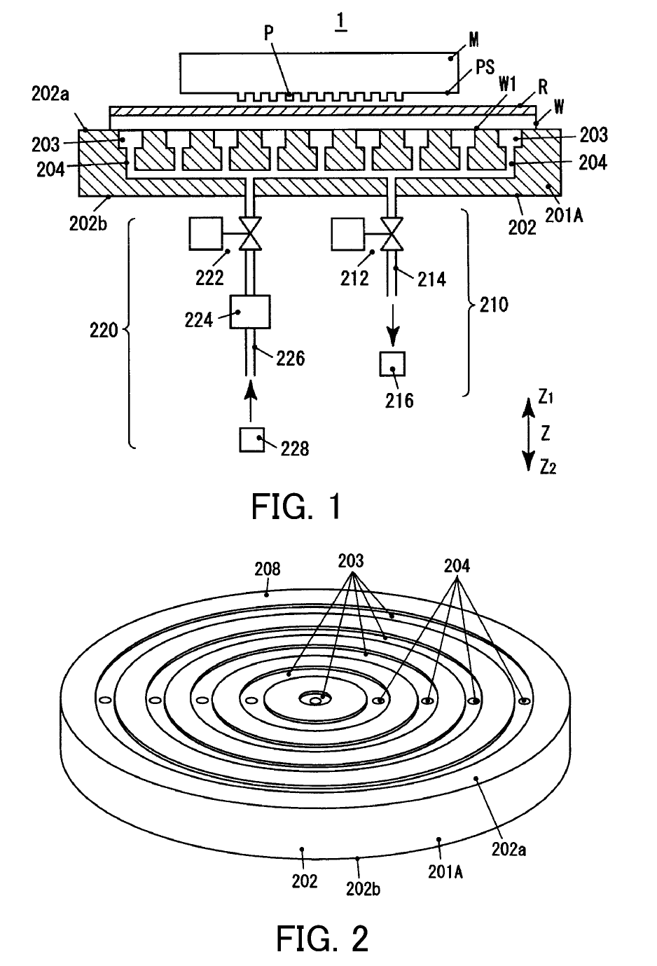

FIG. 1 is a sectional view near a chuck 201A of an imprint apparatus 1 according to a first embodiment. The imprint apparatus 1 is a pattern transfer apparatus (nanoimprint apparatus) configured to press a mold M having a pattern upon a resin (resist) R on a substrate to be transferred, such as a wafer, to release the mold from the resin R, and to transfer the pattern to the substrate W. In FIG. 1, a Z₂ direction is the gravity direction.

The mold M is a transparent material that transmits the ultraviolet (“UV”) light, such as quartz, and has a pattern P on a bottom surface (patterned surface) PS. The resin R of this embodiment is a UV curing resin, but the present invention may use a thermoset resin. The UV curing resin is a resin that cures when receiving the UV, and is a viscose member or liquid before it receives the UV. The substrate W is a rigid substrate, such as a glass substrate, a silicon wafer, and a metallic substrate, and a sheet (or film) in another embodiment.

The imprint apparatus 1 of this embodiment is a photo-curing type nanoimprint apparatus, and is applicable to an article manufacturing apparatus configured to manufacture an article, such as a semiconductor, a micro electro-mechanical system, a medium such as a patterned medium. The imprint apparatus of this embodiment presses a mold upon the substrate, but the substrate may be pressed upon the mold as long as it has a structure configured to reduce a distance between the mold and the substrate.

FIG. 2 is a perspective view of the chuck 201A. Referring to FIGS. 1 and 2, the chuck 201A includes a base 202, an exhaust device 210, and a press device 220. The exhaust device 210 and the press device 220 are separately configured in this embodiment, but the present invention does not prevent them from being made of a common mechanism.

The base 202 has a front surface 202a configured to hold the substrate W that faces the patterned surface PS of the mold M, and a back surface 202b that is a back of the front surface 202a and faces the substrate stage 20. The chuck 201A is a substrate holder configured to vacuum-absorbs (through an application of a negative pressure) the substrate W on the front surface 202a of the base 202 and to hold the substrate W. Moreover, the chuck 201A of this embodiment serves to press the substrate W onto the mold M above the substrate W by applying the (positive) pressure to the back surface W1 (opposite to the surface to which the resin R is applied) of the substrate W arranged on the front surface 202a of the base 202. The base 202 is made of a rigid material (such as metal, ceramic, and resin) which does not easily deform even when the internal pressure changes.

The base 202 has a plurality of grooves 203 in the front surface 202a, and each groove 203 is connected to a pipe 204 at its bottom (on the side of the back surface 202b). The grooves 203 of this embodiment are made of a plurality of concentric circles having the same width as shown in FIG. 2, and it is thus possible to uniformly apply a (negative or positive) pressure to the bottom surface of the disc-shaped substrate W. A shape of the groove 203 is not limited. The pipe 204 connects a plurality of grooves 203 inside of the base 202 to one another. Therefore, when the pipe 204 is set to the negative pressure, all the insides of the plurality of grooves 203 become a negative pressure and the substrate W can be absorbed onto the front surface 202a of the base 202. In addition, when the pipe 204 is set to the positive pressure, all the insides of the plurality of grooves 203 become a positive pressure and the substrate W can be pressed in a direction separating from the front surface 202a of the base 202. The positive pressure in this case needs to be greater than the pressure of the atmosphere of the substrate W. One end of the pipe 204 is connected to the groove 203, and the other end of the pipe 204 projects to the outside from the back surface 202b of the base 202 at two points. The pipe 204 may projected from the side surface of the base 202 to the outside.

The base 202 has a ring-shaped rib 208 on the front surface 202a. The rib 208 has a plane top surface, and improves the adhesion characteristic to the outer circumferential end of the back surface of the substrate W when the substrate W is absorbed onto the shuck 201A. The substrate W is absorbed and held on the chuck 201A so that the center of the disk-shaped substrate W can accord with the center of the base 202.

The exhaust device 210 exhausts the grooves 203 of the chuck 201A by exhausting the inside of the pipe 204 or applying the negative pressure to the inside of the pipe 204. The exhaust device 210 includes a valve 212, a vacuum pipe 214 connected to the pipe 204, and a vacuum pump 216. The valve 212 can open and close the vacuum pipe 214. The valve 212 is, for example, an electromagnetic valve, and its opening and closing can be controlled by a controller 501, which will be described later. The vacuum pump 216 exhausts the vacuum pipe 214 as shown by an arrow towards the Z₂ direction in FIG. 1.

The press device 220 applies to the grooves 203 of the chuck 201A a pressure greater than the pressure of the atmosphere of the substrate W by compressing (or applying the positive pressure to) the inside of the pipe 204). The press device 220 includes a valve 222, a regulator 224, a pressurizing pipe 226 connected to the pipe 204, and a pressurizing tank 228. The press device 220 of this embodiment uses compressed air, but the present invention does not limit a type of gas to be used by the press device to air. The pressure of the atmosphere of the substrate W is, for example, the air pressure, but the pressure is not limited. The valve 222 can open or close the pressurizing pipe 226. The valve 222 is, for example, the electromagnetic valve, and its opening and closing can be controlled by the controller 501, which will be described later. The regulator 224 regulates a flow of the compressed air. The pressurizing tank 228 compresses the pressurizing pipe 226, as shown by an arrow towards a Z₁ direction in FIG. 1.

In this embodiment, as described later, while the resin R cures, the exhaust device 210 stops exhausting the grooves 203 of the chuck 201A and the press device 220 applies a pressure to the grooves 203 of the chuck 201A.

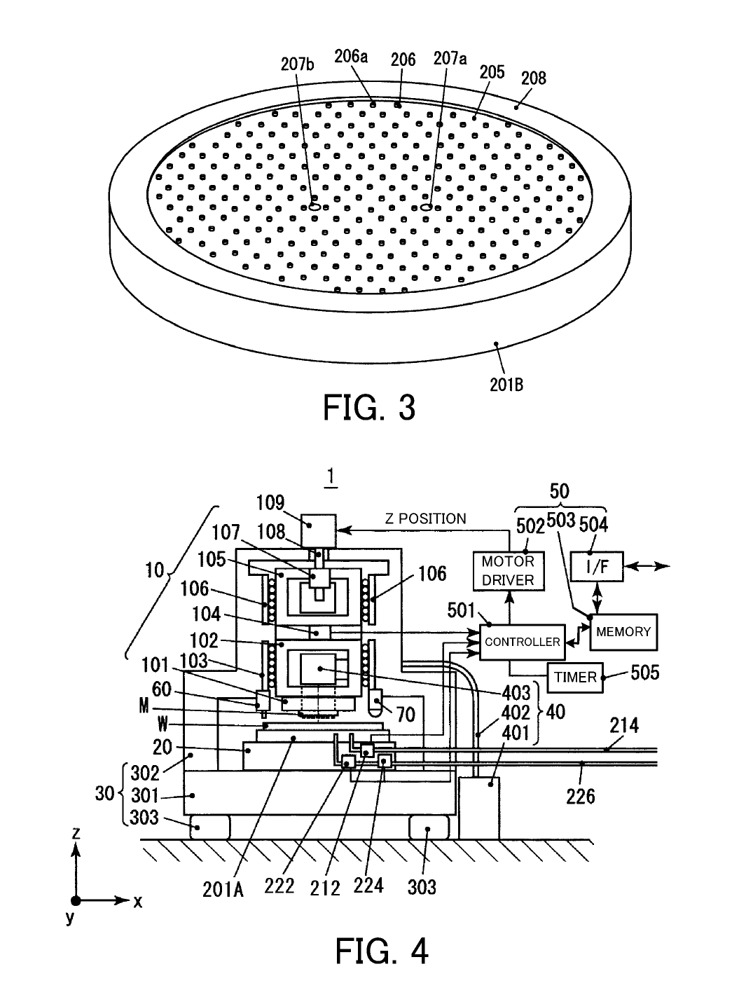

FIG. 3 is a perspective view of a chuck 201B as a variation of the chuck 201A shown in FIG. 2. The chuck 201B has a pin chuck shape, and is suitable for holding the substrate W with a small contact area. Similar to the chuck 201A, the rib 208 is formed around the chuck 201B. A surface 205 lower than the rib 208 is formed inside of the rib 208. Since many cylindrical pins 206 are formed on the surface 205 to reduce the contact area with the back surface W1 of the substrate W in absorbing the substrate W. In this case, the top surface 206a of the pin 206 and the surface of the rib 208 form the front surface of the chuck 201B. The surface 206a of the pin 206 can support the substrate W and make very small the contact area with the back surface W1 of the substrate W. Hence, even when a particle adheres to the back surface W1, this structure prevents the particle from being held between the pin 206 and the back surface W1, and the surface shape of the substrate W from destroying. The surface 205 is provided with an exhaust port 207a connected to the vacuum pipe 214 of the exhaust device 210, and a press port 207b connected to the pressurizing pipe 226 of the press device 220.

FIG. 4 is a schematic sectional view of the imprint apparatus 1. The imprint apparatus 1 of this embodiment is a step-and-repeat nanoimprint apparatus that imprints the mold M smaller than the substrate W, but the present invention is applicable to the nanoimprint apparatus that does not step. The substrate W is divided into a plurality of imprint regions or shots, and the mold pattern is transferred to each shot. According to the imprint apparatus 1, when a transfer of the pattern to one shot among a plurality of shots ends, the substrate W steps to the next shot and the transfer and step on the substrate W are repeated to transfer the pattern to the entire surface of the substrate W.

The imprint apparatus 1 includes an imprint mechanism 10, a substrate stage 20, a structure 30, an illumination system 40, a control system 50, a dispenser 60, and an alignment scope 70.

The imprint mechanism 10 serves as a mold mover configured to move the mold M so as to press the mold M upon the resin R on the substrate and to separate the mold M from the resin R. The imprint mechanism 10 includes a mold stage 101, a first mold driver 102, a first guide 103, a load sensor 104, a second mold driver 105, a second guide 106, a ball nut 107, a ball screw 108, and a motor 109.

The imprint mechanism 10 drives the motor 109 to rotate the ball nut 107, and moves the second mold driver 105, the load sensor 104, and the first mold driver 102 connected to the ball nut 107 together in the longitudinal direction or the Z direction. Thereby, the mold M held by the mold stage 101 connected to the first mold driver 102 imprints the substrate W.

The mold stage 101 serves to hold the mold M, and to change an orientation of the mold M. The mold stage 101 has a structure (also referred to as a flowing mechanism) which can freely change an orientation of the patterned surface of the mold M when the substrate W contacts the mold M via the resin R so that the mold M can follow the substrate surface for the parallel contact between them. The mold stage 101 has an opening at the center part, and allows the UV light configured to cure the UV curing resin to pass through the opening.

The first mold driver 102 is configured to move in the Z direction. The top of the first mold driver 102 is connected to the load sensor 104.

The first guide 103 is a guide mechanism configured to move the first mold driver 102 in the Z direction, and can use a rolling mechanism, such as a ball or a roller. The first guide 103 of this embodiment uses a bearing but may use an air guide.

The load sensor 104 serves as a load detector configured to detect a load applied to the substrate W, and uses a load cell in this embodiment. The load sensor 104 detects the load applied to the mold M when the mold M is pressed against the substrate W (and the load in the compression direction occurs because there is an imprinting force) or when the mold M is separated from the substrate W (and the load in the tensile direction occurs because there is a release force). A detection result by the load sensor 104 is used to control driving of the mold M. More specifically, the detection result is used to control the imprinting force of the mold M at the transfer time, and to determine the operation timing of the valve configured to switch the absorption of the substrate W, and applying a high pressure to the back surface. The top of the load sensor 104 is connected to the second mold driver 105.

Similar to the first mold driver 102, the second mold driver 105 is configured to move only in the Z direction. The top of the second mold driver 105 is connected to the ball nut 107. The second mold driver 105 moves in the longitudinal direction (Z direction) as the ball screw 108 engaged with the ball nut 107 rotates.

The second guide 106 is a guide mechanism configured to move the second mold driver 105 in the Z direction, similar to the first guide 103. The motor 109 is connected to the ball screw 108. As the motor 109 drives, the second mold driver 105, the load sensor 104, and the first mold driver 102 connected to the ball nut 107 engaged with the ball screw 108 move longitudinally.

The substrate stage 20 moves the substrate W in the XY plane. The substrate stage 20 holds the substrate W, and controls the orientation of the substrate W. The substrate stage 20 serves to move and position the substrate W in the XY plane. The substrate stage 20 steps in the X or Y direction in sequentially transferring the pattern of the mold M. A position and orientation of the substrate stage 20 are precisely controlled by a laser interferometer (not shown) so as to make uniform the distribution of the residual layer thickness. The substrate stage 20 is mounted with the chuck 201A configured to hold the substrate W. The chuck 201A is connected to the exhaust device 210 and the press device 220.

The structure 30 supports the entire imprint apparatus 1. The structure 30 includes a table 301, a frame 302, and dampers 303. The table 301 bears the rigidness of the entire imprint apparatus 1, and supports the substrate stage 20 and the frame 302. The table 301 is placed on the floor via the dampers 303. The dampers 303 shield the vibrations from the floor so as to maintain the high positioning precision required by the substrate stage 20. The damper 303 is, for example, an air damper.

The illumination system 40 is a cure device configured to cure the resin R. The illumination system 40 includes a lamp box 401, an optical fiber 402, and an illumination optical system 403. The UV light configured to cure the UV curing resin is generated by a high-pressure mercury lamp in the lamp box 401, and introduced to the imprint apparatus 1 via the optical fiber 402. An angle of view and an intensity distribution of the UV light introduced to the imprint apparatus 1 are adjusted by the illumination optical system 403, and irradiated onto the resin R on the substrate W through the mold M. The illumination optical system 403 is arranged inside of the first mold driver 102. The illumination optical system 403 includes, for example, a lens unit configured to make a luminance distribution uniform, and a mirror configured to reflect the UV light so as to irradiate the UV light through the opening in the bottom of the first mold driver 102.

The control system 50 controls driving of the imprint mechanism 10, and driving of each valve connected to the chuck. The control system 50 includes a controller 501, a motor driver 502, a memory 503, an interface part 504, and a timer 505, and controls the imprint mechanism 10 configured to drive the mold M in the Z direction. The controller 501 operates and processes the detection result of the load sensor 104, and outputs a drive signal to the motor driver 502. The controller 501 outputs a control signal of opening and closing of the valves 212 and 222, and a control signal for the regulator 224. Thus, the controller 501 controls the operations of the imprint mechanism 10, the exhaust device 210, and the press device 220 based on the detection result of the load sensor 104. The motor driver 502 drives the motor 109 in accordance with the drive signal from the controller 501. The interface part 504 communicates data, such as an input of the control parameter to the control system 50, between the apparatus and the external device. The memory 503 stores a control parameter, etc. The timer 505 measures a set time period.

The dispenser 60 dispenses the resin R on the substrate W. The dispenser 60 is a mechanism that dispenses the resin R onto the substrate W, and serves to dispense the UV curing resin onto a pattern transfer position of the mold M. When the UF curing resin is previously coated on the entire substrate W, the dispenser 60 is omitted.

The alignment scope 70 measures a position of the substrate W. The alignment scope 70 is held by the frame 302, and measures an alignment mark arranged on the substrate W in transferring the pattern of the mold M onto the substrate W. The alignment scope 70 is used for the alignment between the mold M and the substrate W.

A description will now be given of an operation of the imprint apparatus 1. Initially, the mold M is imported into the imprint apparatus 1 by a mold transport system (not shown), and attached to a mold stage 101. Next, a measurement system (not shown) measures an orientation of the patterned surface of the mold M, and the mold stage 101 is driven based on the measurement result so as to accord the orientation of the mold M with an apparatus reference. The apparatus reference is, for example, a scanning surface (XY plane) of the substrate stage 20.

Next, a substrate transport system (not shown) imports the substrate W into the imprint apparatus 1. The fed substrate W is vacuum-absorbed by the chuck 201A. At this time, the valve 212 is opened, the grooves 203 and the pipes 204 become vacuum, and the substrate W is absorbed by the chuck 201A. The alignment scope 70 is used to measure the alignment mark on the substrate W a plurality of times, and the position (such as a X position, a Y position, and a rotational position on the XY plane) of the substrate W in the imprint apparatus 1 is operated based on the measurement result (global alignment). The substrate W is positioned at a predetermined position on the substrate stage 20 based on the operation result.

Next, the pattern of the mold M is sequentially transferred onto the substrate W. The transfer operation includes an imprint step, a cure step, and a release step.

In the imprint step, the dispenser 60 dispenses the resin R at a position of the substrate W onto which the pattern of the mold M is to be transferred. The substrate stage 20 positions the substrate W at a position just under the mold M, and the imprint mechanism 10 is driven to press the mold M upon the substrate W. Thereby, the resin R flows along the patterned surface of the mold M (or the pattern formed on the mold M). The controller 501 monitors a value of the load sensor 104 in pressing the mold M upon the substrate W, and determines whether the mold M contacts the substrate W. When the load becomes a preset value after the mold M contacts the substrate W, the controller 501 closes the valve 212 and simultaneously opens the valve 222. Then, the high-pressure air is introduced to the grooves 203 in the chuck 201A through the pressurizing pipe 226 from the pressurizing source. The pressure is controlled to an appropriate value, such as 3 kgf/cm², by the regulator 224. As the pressure on the back surface of the substrate rises, the substrate W is pressed on the mold side. As a result, the deformation of the part of the back surface of the substrate corresponding to the grooves 203 can be eliminated, and pressed upon the mold M.

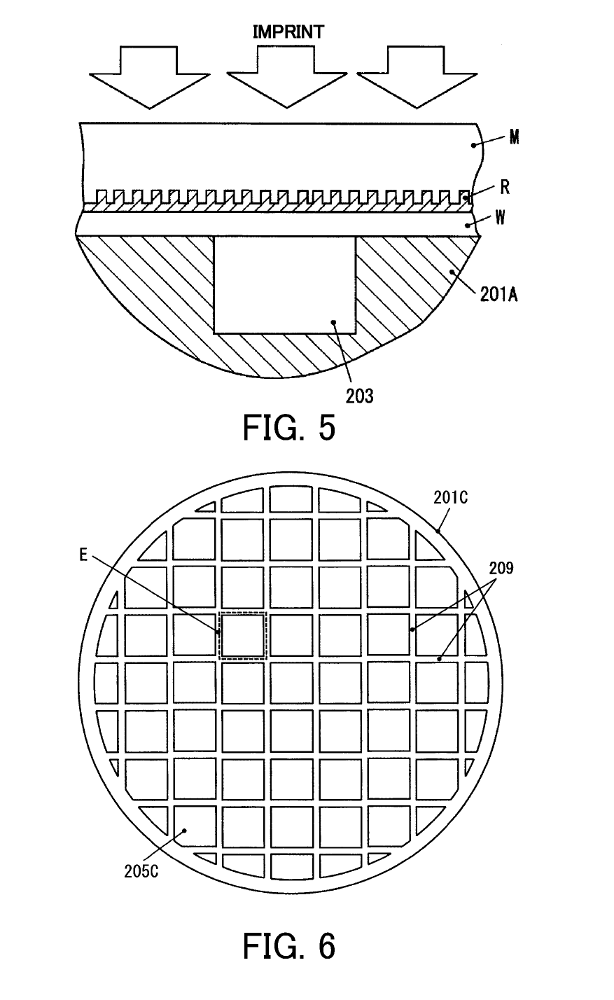

FIG. 5 is a sectional view of the high-pressure state of the grooves 203. While the imprint mechanism 10 presses the mold M upon the resin R on the substrate W, the unevenness of the residual layer thickness caused by the shapes of the grooves 203 in the chuck 201A is eliminated and a uniform residual layer thickness can be obtained. Even when the back surface W1 of the substrate W becomes high pressure (for example, as high as the pressure of 2 kgf/cm²), the substrate W does not move because the substrate W is supported by the mold M from the top.

Thus, the controller 501 controls the exhaust device 210 to continue to exhaust the chuck 201A and controls the press device 220 to stop applying the pressure to the grooves 203 until the load sensor 104 detects a present value after the imprint mechanism 10 moves the mold M to the substrate W. This configuration can prevent a positional shift between the mold M and the substrate W before imprinting. In addition, the controller 501 controls the exhaust device 210 to stop exhausting the grooves 203 in the chuck 201A and controls the press device 220 to apply the pressure to the grooves 203, when the load sensor 104 detects the preset value. This configuration facilitates the resin to spread and follow the pattern P of the mold M during imprinting.

The imprint mechanism 10 controls and opens the valve 212 based on the detection result of the load sensor 104 so as to keep the predetermined load value. After the timer 505 measures a predetermined time period, the illumination system 40 irradiates the UV onto the resin R through the mold M and cures the resin R (cure step). At this time, the load is maintained to the predetermined value.

While the imprint step of this embodiment presses the back surface of the substrate, it is the cure step that determines the residual layer thickness and thus at least only the press device may operate in the cure step. Thus, according to this embodiment, while the illumination system 40 cures the resin R, the exhaust device 210 stops exhausting the grooves in the chuck 201A and the press device 220 applies the pressure to the grooves 203 in the chuck 201A. This configuration can prevent an insertion of part of the back surface W1 of the substrate W into the grooves 203, maintaining a uniform distribution of the residual layer thickness.

When the cure step is completed, the release step starts. After the cure is completed, the controller 501 again closes the valve 222 and opens the valve 212. In other words, when the timer 505 measures a set time period after the load sensor 104 detects the preset value, the controller 501 controls the exhaust device 210 to exhaust the grooves 203 in the chuck 201A, and controls the press device 220 to stop applying the pressure to the grooves 203. Thereafter, the imprint mechanism 10 is controlled so that the mold M is moved and released from the resin R on the substrate W.

As a result, while the imprint mechanism 10 releases the mold M from the resin R on the substrate W, the exhaust device 210 exhausts the grooves 203 of the chuck 201A, and the press device 220 stops applying the pressure to the grooves 203 in the chuck 201A, and the substrate W is absorbed on the chuck 201A. At this state, the release operation follows because if the back surface of the substrate W is pressed at the release time, the substrate W follows a rise of the mold M and the release is unavailable. Since the substrate W is absorbed on the chuck 201A, the mold M is separated from the substrate W.

When the transfer operation is thus completed, the substrate W has a replica pattern that is made of the UV curing resin and corresponds to the pattern of the mold M. Then, the substrate stage 20 is driven, the UV curing resin is dispensed on the next transfer position of the substrate W, and the substrate W is moved to the transfer position so as to repeat the above imprint step, cure step, and release step.

Thus, the imprint step and the cure step compress the back surface of the substrate W while the mold M contacts the substrate W, eliminating the shape changes depending upon the absorption surface of the chuck 201A and providing uniform imprinting. Moreover, even when the mold M has bad flatness, the resin R on the substrate W can follow the shape of the patterned surface of the mold M, providing a more uniform residual layer thickness.

### Second Embodiment

FIG. 6 is a plane view of a chuck 201C of a second embodiment. Each of the chucks 201A and 201B maintains the entire back surface of the substrate W to the positive pressure at the cure time and at the imprint time, the chuck 201C has a rib 209 that extends two-dimensionally along with the area in which the pattern of the mold M is to be formed. A plurality of rectangular concaves 205C are formed inside of the rib 209, and an exhaust port and a press port (not shown) are formed in each concave 205C. The concave 205C is approximately equal to or slightly larger than a mold size (transfer range) E shown by a dotted line.

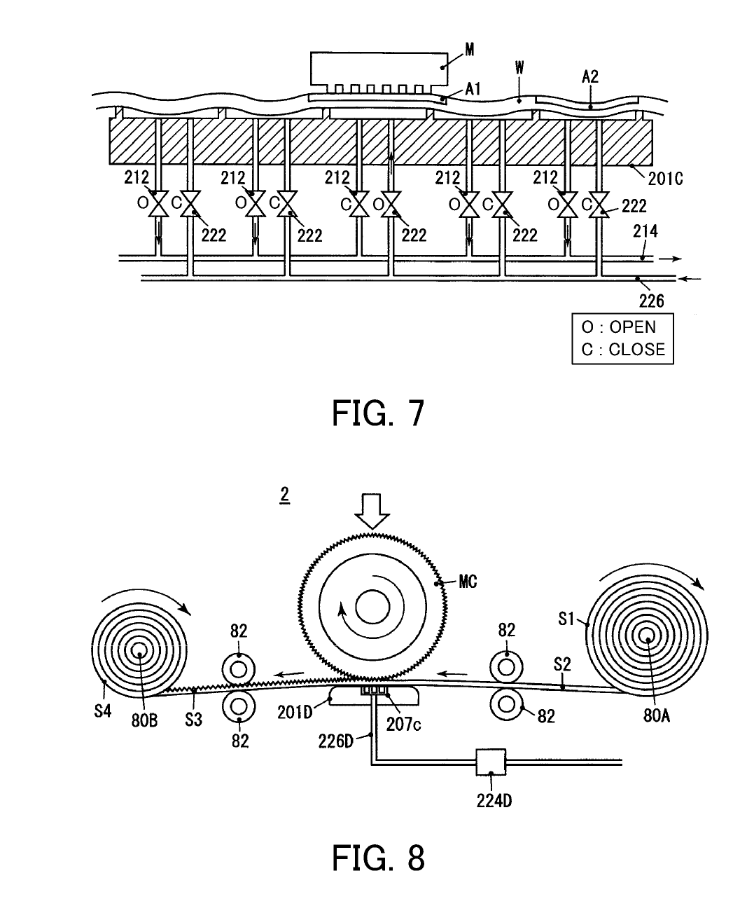

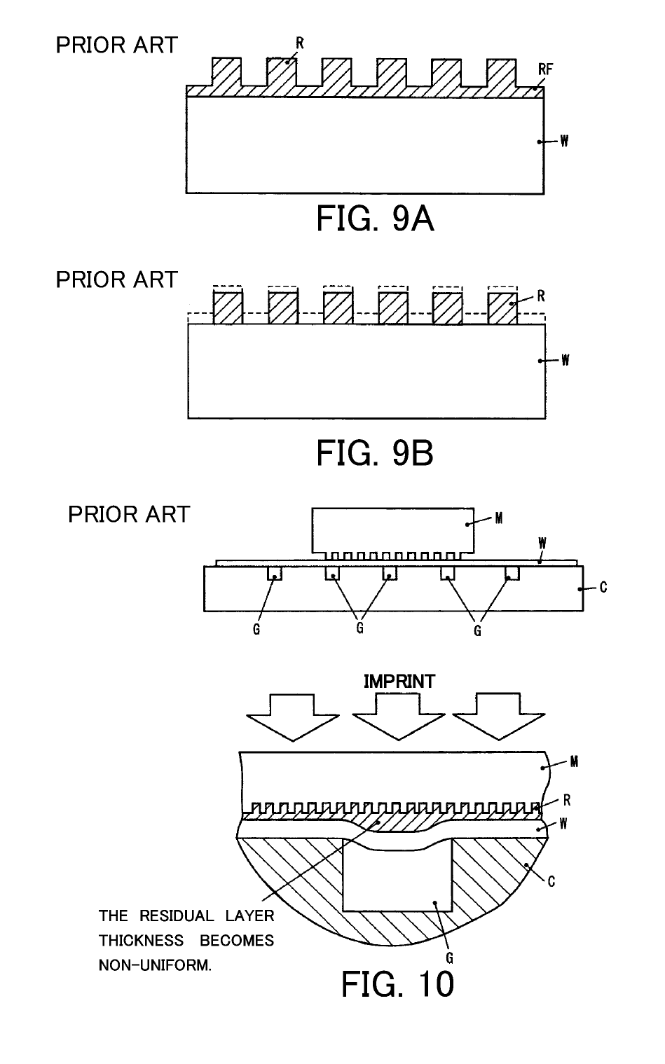

Exhaust and press can be switched for each concave 205C, and only the imprint region (shot) can be switched to the positive pressure at the imprint time, and other concaves 205C can be exhausted and absorbed (FIG. 7). Each concave 205C may have one or more grooves. Thus, the chuck 201C has one or more grooves (concaves) 205C provided for each imprint region. The exhaust device can exhaust the groove corresponding to each imprint region individually, as shown in FIG. 7. The press device can apply the pressure to the groove corresponding to each imprint region individually. In FIG. 7, each concave 205C is provided with the valves 212 and 222, and the vacuum pipe 214 and the pressurizing pipe 226 are opened and closed.

The illumination system 40 of this embodiment can cure at least part of the resin on each imprint region. Here, “at least part” intends to allow a structure that separates the imprint position from the release position, provides a stripe-shaped illumination system 40 between them, and moves the substrate stage 20 from the imprint position to the release position.

The positive pressure applied during imprinting and curing can prevent a slip and a resultant positional shift between the surface of the chuck 201C and the substrate W. This embodiment divides the absorption surface of the chuck 201C in accordance with the transfer size, and maintains only the imprint region to the positive pressure. In other words, when the illumination system 40 cures the resin on the imprint region A1 (first imprint region), the exhaust device 210 stops exhausting of the concave 205C (first groove) corresponding to the imprint region A1. The exhaust device 210 exhausts the concave 205C (second groove) corresponding to the imprint region A2 (second imprint region) other than the first imprint region. In addition, the press device 220 compresses the concave 205C corresponding to the (first) imprint region A1 and stops applying the pressure to the concave 205C corresponding to the (second) imprint region A2.

The absorption surface may be divided into the absorption area and the positive pressure area, and the number of divisions is not limited as long as the entire back surface of the imprint region can be maintained to the positive pressure. When the mold M does not contact the substrate W, for example, when the substrate W is moved to a predetermined position, the entire surface of the substrate W is absorbed; in the imprint time, the entire region in which the mold M contacts the substrate W is controlled to the positive pressure.

### Third Embodiment

FIG. 8 shows a roller imprint apparatus 2 of a third embodiment. The roller imprint apparatus 2 is an imprint apparatus configured to press the roller mold MC having a pattern upon the resin on the sheet, to release the roller mold MC from the resin, and to continuously transfer the mold pattern onto the sheet. S1 is a pre-transferred resin roll, and the resin sheet is wound around and attached to a feed shaft 80A. S2 is a resin sheet fed from the resin roll S1. The resin sheet S2 is pressed and held by the top and bottom rotating drive rollers 82, and moved in the left direction in FIG. 8.

A sheet holder 201D is arranged under the roller mold MC so as to press the sheet upon the roller mold MC. A heater is installed so as to raise the temperature to soften the resin sheet S2. A press port 207c is formed just under a load applied position of the roller mold MC, and a high-pressure gas is supplied through the pipe 226D. A regulator 224D is located in the middle of the pipe 226D so as to always maintain the appropriate pressure.

As the roller mold MC rotates, the pattern is transferred onto the surface of the resin sheet S2 and turns the resin sheet S2 into a sheet S3. The sheet S3 is sequentially rolled up, via the drive rollers 82, by a take-up roll S4 attached to a take-up shaft 80B.

If a smooth roller is provided on the back surface side of the sheet and the dust adheres to the back surface of the sheet, a non-uniform load is applied to the sheet and the transfer shape deteriorates as a result of that the roller mold MC transfers the pattern to the resin sheet S2. On the other hand, according to this embodiment, the sheet holder 201D configured to always support the load does not directly contact due to the high-pressure gas, and the transfer is not subject to the transfer shape even when the particle adheres to the back surface.

A manufacturing method of a device (such as a semiconductor integrated circuit device or a liquid crystal display device) includes transferring a pattern onto the substrate (such as a wafer, glass plate, and a film-shaped substrate) using the imprint apparatus of one of the above embodiments, and etching the substrate. An article manufacturing method of manufacturing a medium, such as a patterned medium or an article, does not need etching, but includes processing the transferred substrate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-232791, filed Sep. 11, 2008, which is hereby incorporated by reference herein in its entirety.

What is claimed is:

1. An imprint apparatus for molding a resin on a substrate using a mold to form a pattern of a resin on the substrate, the apparatus comprising:
a holder having a groove and configured to hold the substrate;
an exhaust device configured to exhaust a gas in the groove so that a pressure in the groove is negative and the holder holds the substrate;
a supply device configured to supply a gas to the groove; and
a controller configured to control the supply device so that a pressure in the groove is positive during the molding.

2. An imprint apparatus according to claim 1, further comprising a mechanism configured to press the resin on the substrate and the mold to each other, and to release the resin on the substrate and the mold from each other,
wherein the controller is configured to cause the exhaust device to stop exhaust and cause the supply device to start supply, with respect to at least part of the groove, in accordance with pressing by the mechanism.

3. An imprint apparatus according to claim 2, wherein the controller is configured to cause the exhaust device to perform exhaust with respect to the at least part of the groove during releasing by the mechanism.

4. An imprint apparatus according to claim 2, further comprising a detector configured to detect a force of pressing by the mechanism,
wherein the controller is configured to cause the exhaust device to stop exhaust and cause the supply device to start supply in accordance with an output of the detector.

5. An imprint apparatus according to claim 1, further comprising a cure device configured to cure the resin being pressed by the mechanism,
wherein the controller is configured to control the supply device so that a pressure in the groove becomes negative after curing by the cure device.

6. An imprint apparatus according to claim 1, wherein the holder includes, as the groove, a plurality of grooves that are separated from each other so that exhaust by the exhaust device and supply by the supply device can be performed independently with respect to each of the plurality of grooves.

7. An imprint apparatus for molding a resin on a sheet using a mold to form a pattern of a resin on the sheet, the apparatus comprising:
a holder having a groove and configured to hold the sheet so as to press the sheet to the mold;
a supply device configured to supply a gas to the groove; and
a controller configured to control the supply device so that a pressure in the groove is positive and the holder is non-contact with the sheet during the molding.

8. A method of manufacturing an article, the method comprising:
forming a pattern of a resin on a substrate using an imprint apparatus defined in claim 1; and
processing the substrate on which the pattern is formed to manufacture the article.

9. A method of manufacturing an article, the method comprising:
forming a pattern of a resin on a sheet using an imprint apparatus defined in claim 7; and
processing the sheet on which the pattern is formed to manufacture the article.
